(19) United States
(12) Patent Application Publication
(10) Pub. No.: US 2007/0280377 A1
(43) Pub. Date: Dec. 6, 2007

(54) APPARATUS AND METHOD FOR CONTROLLING THE OUTPUT POWER OF A TRANSMITTER USING A PILOT CHANNEL POWER LEVEL

(76) Inventor: John S. Rucki, New Providence, NJ (US)

Correspondence Address: WOOD, HERRON & EVANS, LLP, 2700 CAREW TOWER, 441 VINE STREET, CINCINNATI, OH, 45202, US

(21) Appl. No.: 11/421,950

(22) Filed: Jun. 2, 2006

(51) Int. Cl. H04L 25/03

(52) U.S. Cl. 375/296

(57) ABSTRACT

A circuit for controlling the output power of a transmitter including a power amplifier includes a pilot detection circuit for detecting the power of a pilot channel from an output of the amplifier. The pilot detection circuit provides a pilot power output signal reflective of the pilot channel power.

A reference circuit provides a pilot power reference signal, and a comparator circuit compares the pilot power output signal and reference signal and provides a power level correction signal.

A level adjustment circuit adjusts the power level of an input to the amplifier and uses the power level correction signal to vary the amplifier input to control the output power level of the amplifier.

### FIELD OF THE INVENTION

The present invention is directed generally to wireless RF communications, and particularly to controlling the power level of an RF transmitter.

### BACKGROUND OF THE INVENTION

In telecommunications systems, such as cellular systems utilizing CDMA and WCDMA, the communications for multiple mobile devices, such as phones, are conducted over the same bandwidth and the individual signals are then separated and distinguished from one another by modulating and demodulating the transmitted data utilizing pseudo-random noise codes known to both the receive and transmit systems. In such a scenario, the communications of other mobile devices appear as background noise and interference to each mobile device during the processing of any one particular communication stream.

To eliminate the interference, the RF transmitters utilized in such communication protocols employ transmit power control in order to use the available shared bandwidth more efficiently. Transmit power control keeps the transmit power of each communication link with a mobile device near the minimum necessary in order to conduct communications successfully. That is, the transmit power control facilitates the processing of a particular communication stream by reducing the level of background noise generated by the other communication streams.

Setting and holding an accurate RF power level at the output of a transmitter has historically been a difficult task to accomplish. This is especially true when trying to hold tight tolerances and when dealing with complex modulated waveforms, such as those found in the above-noted CDMA and WCDMA wireless communication applications. The transmitted signals have constantly changing power levels based on the number of users and devices associated with the transmitter, such as the number of mobile phones communicating with a particular cellular base station. The types of services being transmitted also are constantly changing.

For power control, detectors are often used for measuring power at the output of a transmitter. Such detectors are often adversely affected by the continual power fluctuations. Therefore, long term averaging of the detected power levels is normally used to smooth out the power changes and to get an accurate reading of the transmitted power. This averaging, however, also introduces measurement uncertainties in terms of knowing the absolute power that is being broadcast from the transmitter at any selected point in time.

To maintain an accurate absolute transmission power at the output of a transmitter, it is required that both the source power and the transmission path gain are accurate and stable over time and temperature. However, such accuracy and stability is not always achieved and thus error is introduced by source power uncertainty and the uncertainty in the net gain of the transmission path. If absolute power at the end of the transmission path can be accurately measured, then level adjustments to the input signal and/or gain level adjustments can be made utilizing an automatic level control (ALC) algorithm. With such an ALC algorithm and circuit, the final transmitted power error is then equal to the error introduced by uncertainties in the measurement path and the detector itself.

The present invention is directed to addressing shortcomings in setting and holding an accurate RF power level at the output of a transmitter and to eliminating uncertainties associated with the source power, the net path gain, and existing measurement techniques.

### BRIEF DESCRIPTION OF THE DRAWINGS

The accompanying drawings, which are incorporated in and constitute a part of this specification, illustrate embodiments of the invention and, together with a general description of the invention given above and the Detailed Description given below, serve to explain the invention.

FIG. 1 is a block diagram of one embodiment of the invention.

FIG. 2 is a block diagram of another embodiment of the invention.

FIG. 3 is a block diagram of another embodiment of the invention.

### DETAILED DESCRIPTION OF EMBODIMENTS OF THE INVENTION

The present invention provides a method of absolute power control for the output of an RF transmitter that avoids the prior art uncertainties in measuring the total power of the transmitted signal. Embodiments of the invention involve the measurement of the time invariant portion of the waveform, namely, the power of the pilot channel. The pilot power of a CDMA and/or WCDMA carrier is prescribed by industry standards to be a constant fraction of the fully loaded, all Walsh codes “ON,” power. When absolute power measurements are made on only the pilot channel of a carrier and not the whole carrier, as in the present invention, then the errors incurred by long term averaging of a carrier's total power are completely avoided. When the automatic level control (ALC) algorithm loop makes use of the pilot-only power and holds this level fixed to a precise reference, as in the present invention, the output powers of the other codes are transmitted at the appropriate levels.

For example, if a transmitter is to provide a 10 Watt CDMA signal at the antenna port, and the pilot channel percentage of the fully loaded carrier is defined to be 20 percent, then, as long as the pilot channel power is measured and held to 2 Watts at that port, as in the present invention, the transmission power of the other codes will be on target. If the carrier is then fully loaded with traffic, the transmitted power will equal exactly 10 Watts.

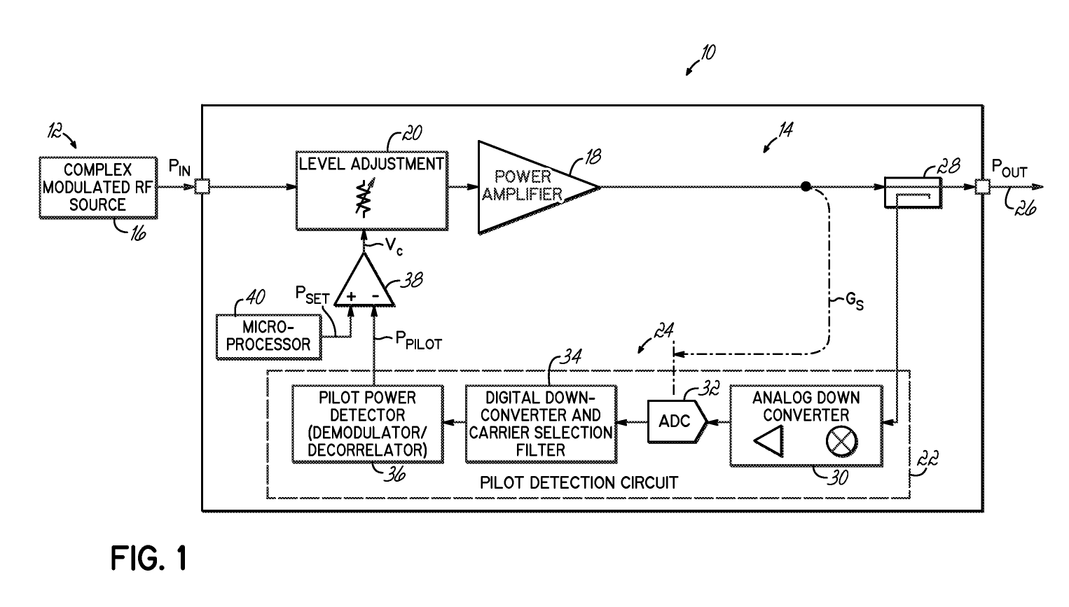

Turning to FIG. 1, an exemplary embodiment is illustrated for a generic transmitter and transmission path which includes a modulated source and input signal, and a gain stage. Generally, the gain stage will incorporate one or more power amplifiers. To that end, transmitter 10 includes a source or input stage 12 and a gain stage 14. Input stage 12 includes an RF source, such as a complex modulated RF source or transceiver 16 which provides an input or input signal P_{IN}. The gain stage 14 includes a power amplifier 18 and a gain adjustment or level adjustment circuit 20 for adjusting the level of the input signal P_{IN} to the power amplifier 18. In accordance with one embodiment of the invention, transmitter 10 incorporates a pilot detection circuit 22 into the automatic level control loop 24. The pilot detection circuit 22 detects the power of a pilot channel from a carrier in the output of amplifier 18 and provides a pilot power output signal P_{PILOT}. The detected pilot power output signal P_{PILOT} is then compared with a user-defined set point or reference signal P_{SET} to generate a power level correction signal or gain correction signal V_{C} that is used by the level adjustment circuit 20 for adjusting the power level of an input to the amplifier 18.

Specifically, referring again to FIG. 1, source or transceiver 16 transmits at a power level P_{IN} and drives the start of the transmit path. The level adjustment circuit 20 then adjusts or tunes the net gain of the transmit path by varying the power level of the input to the amplifier and ultimately setting the desired output power P_{OUT} from the amplifier and transmitter that is delivered at the antenna port 26. The adjusted input signal P_{IN} passes from level adjustment circuit 20 through to power amplifier 18 where it is amplified and also passes through a coupler 28 before exiting at the antenna port 26 at power level P_{OUT}. The directional coupler 28 provides a sample of the transmitted RF energy of P_{OUT} to the pilot detection circuit 22 and specifically a sample of one or more carriers and their respective pilot channels.

The pilot detection circuit includes an analog downconverter 30 that downconverts the RF signal such as to IF. The downconverted RF signal is then sampled by a high speed analog-to-digital converter (ADC) 32. The sample of the output signal P_{OUT} will include one or more carriers in accordance with the transmission protocol, such as a CDMA transmission protocol. Each of the carriers includes individual channels. One such channel is the pilot signal channel or pilot channel.

Once a carrier is captured in the digital domain, digital signal processing is used to mix or downconvert the targeted carrier to base-band frequency. To that end, the pilot detection circuit 22 includes a digital downconverter as well as a digital filter for selecting the pilot channel of the carrier, as illustrated collectively by block 34. While the digital downconverter and filter are illustrated in the same block 34, they could also be incorporated into separate circuits or indicated by separate circuit blocks within the block diagram of FIG. 1. Similarly, the various individual blocks of the block diagram are not limiting with respect to how those functions might be incorporated within a circuit.

The pilot detection circuit 22 also incorporates a pilot power detector which includes a demodulator/decorrelater. The pilot power detector 36 de-spreads the selected carrier into its individual channels and then makes a power measurement on only the pilot channel. In that way, the pilot detection circuit provides a pilot power output signal P_{PILOT} reflective of the pilot channel power. The embodiment illustrated in FIG. 1 may be utilized for a transmitter having a single carrier. However, the invention is also suitable for use with multi-carrier transmitters as discussed below.

Once the pilot channel power is measured with generation of the resulting pilot power output signal P_{PILOT}, a comparator circuit is used to compare the pilot power output signal P_{PILOT} and a pilot reference signal P_{SET}, which may be user defined. P_{SET}, for example, might be provided by a microprocessor circuit 40. The result of such comparison in comparator circuit 38 produces a power level correction signal V_{C}. Power level correction signal V_{C} is reflective of the difference between the measured pilot power P_{PILOT} and the user-defined set point or reference P_{SET}. The level adjustment circuit 20 utilizes the power level correction signal V_{C} and thus varies the level of the input to the amplifier and the net gain of gain stage 14 to provide a power level P_{OUT} at the antenna port 26 to force the two power signals P_{PILOT} and P_{SET} to be generally equal. Once the feedback loop including the pilot detection circuit 22 forces the two quantities P_{PILOT} and P_{SET} to be generally equal, the transmitted level of power P_{OUT} at the antenna port is known to be on target.

The variable nature of the total carrier power does not affect the power measurement in any way in the present invention. The only uncertainty that may be left in the transmitted power accuracy is any uncertainty in the sample path gain indicated as G_{S} FIG. 1. The error introduced by source power uncertainty and the net gain uncertainty are completely removed. As such, the present invention provides a way of setting and holding an accurate RF power level at the output of the transmitter 10 or at the output of a gain stage including amplifier 18.

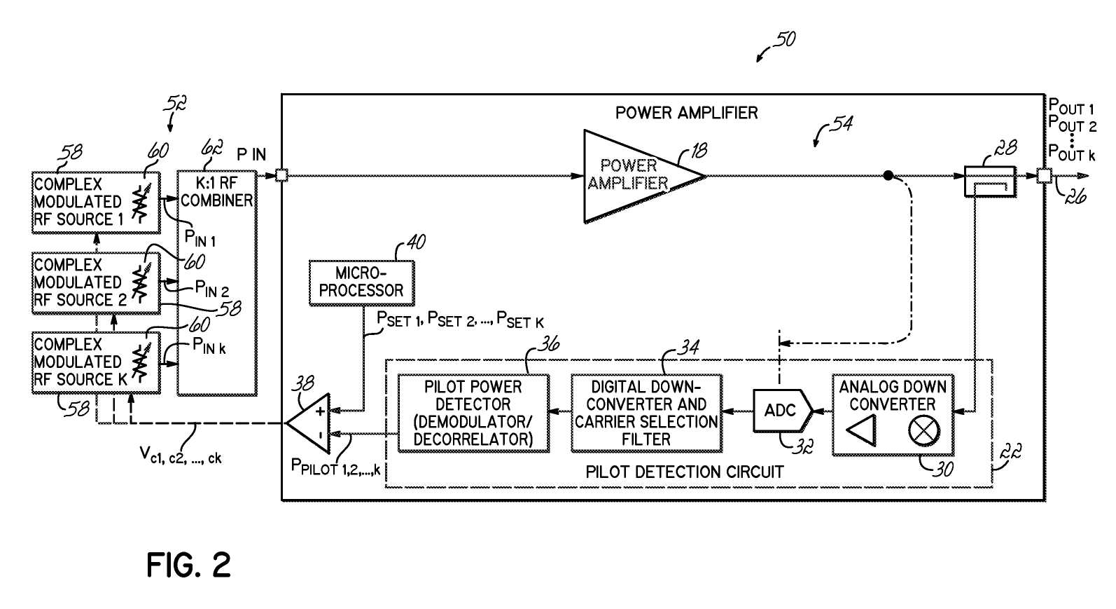

As noted above, the circuit of FIG. 1 might be utilized for a transmitter utilizing a single carrier. However, the present invention might also be utilized for multi-carrier transmitters to realize the benefit from the pilot channel detection scheme of the invention by removing the gain uncertainties caused by operation of multiple carriers over wide bandwidths. To that end, FIG. 2 illustrates another embodiment of the invention for multi-carrier transmitters. Like reference numerals for like components from FIG. 1 are used in FIG. 2. Specifically, multi-carrier transmitter 50 includes a modulated source or transceiver 52 and a gain stage 54 incorporating a power amplifier 18 similar to FIG. 1. Modulated source 52 incorporates a plurality of complex modulated RF signal sources 1-k illustrated as elements 58 in FIG. 2. Each of the RF sources 58 incorporate internal level adjustment circuits 60 that utilize the power level correction signals V_{C1}, V_{C2}, . . . V_{Ck}. As such, FIG. 2 utilizes an external control loop, as opposed to FIG. 1 which incorporates a level adjustment circuit 20 within the power amplifier stage or gain stage 14 of the overall transmitter 10. In FIG. 2, the level adjustment circuits 60 of the modulated RF sources 58 in the multi-carrier transceiver circuit are utilized. The transceiver circuit 52 also incorporates an appropriate RF combiner circuit 62 for combining the input signals P_{IN1}, P_{IN2}, . . . P_{INk}. Transmitter 50 thus provides output signals at the antenna port indicated by P_{OUT1}, P_{OUT2}, and P_{OUTk} that are reflective of the multiple carriers.

Referring now to FIG. 2 in the pilot detection circuit, coupler 28 couples off a portion of the output power P_{OUT} wherein it is downconverted by downconverter 30, captured in a digital domain by ADC 32 and then digitally downconverted and filtered for selecting the individual carriers of the input signals P_{IN1}, P_{IN2}, . . . P_{INk}. The transmit carrier signals, as noted, are sourced by individual transceivers or RF sources 58. Each carrier has its pilot channel power level monitored by the pilot power detector 36 of the pilot detection circuit 22 in the form of P_{PILOT1}, P_{PILOT2}, . . . P_{PILOTk}. The measured pilot power output signal P_{PILOT1}-P_{PILOTk} is compared to the user-defined pilot power set point or pilot power reference signal P_{SET} to generate a plurality of respective power level correction signals V_{C1}, V_{C2}, . . . V_{Ck}. Each of the sources 58 then utilize the individual level adjustment circuits 60 for adjusting the power level of the inputs to the amplifier P_{IN1}, P_{IN2}, . . . P_{INk} utilizing the appropriate power level correction signals V_{C1}, V_{C2}, . . . V_{Ck} for varying the amplifier input or source input to control the output power level of the power amplifier 56 or the overall transmitter 50. In that way, the proper final transmission level at the antenna port P_{OUT1}, P_{OUT2}, . . . P_{OUTk} is achieved.

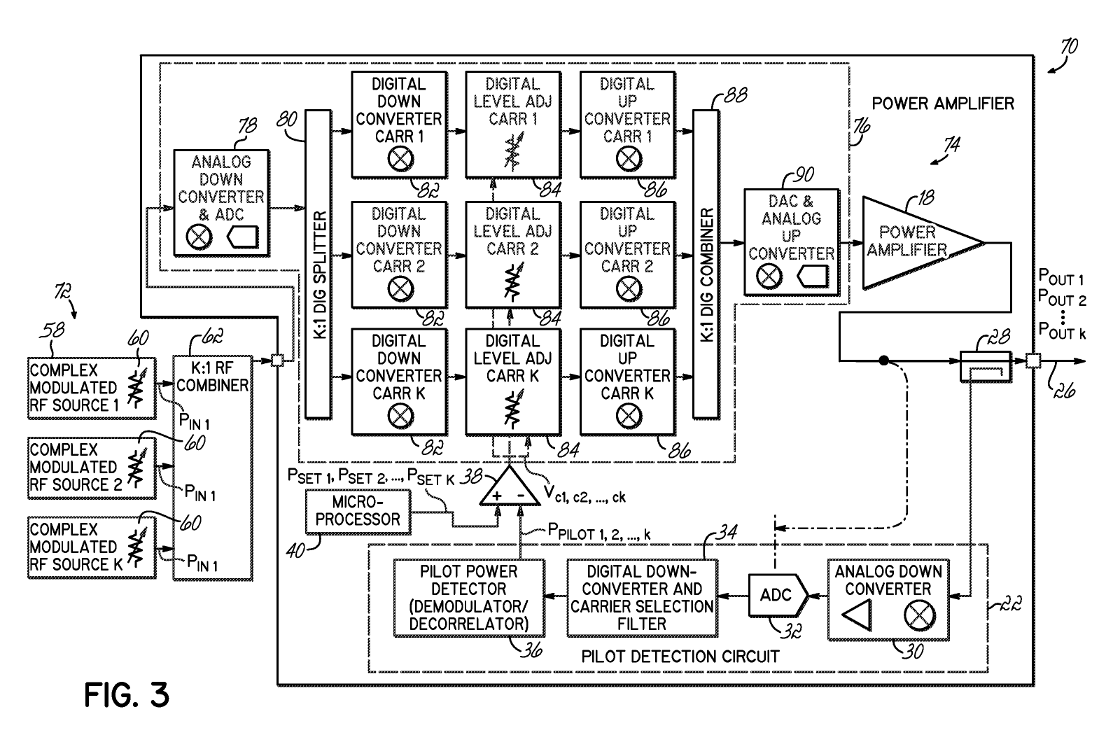

While one embodiment might use a single user-defined pilot power set point or pilot power reference signal P_{SET}, for comparison to the measured pilot channel power levels, other embodiments, as show in FIGS. 2 and 3 might use multiple individual P_{SET} levels. For example, individual P_{SET} levels, such as P_{SET 1}, P_{SET 2}, . . . , P_{SET k}, might be used for setting unique target power levels for each carrier. In such a case, the measured pilot channel power levels in the form of P_{PILOT1}, P_{PILOT2}, . . . P_{PILOTk}, would be compared to individual corresponding set levels P_{SET 1}, P_{SET 2}, . . . P_{SET k}, for adjusting the output power of the transmitter.

It may not be possible to provide necessary feedback to the various source transceivers 58, thus an alternate embodiment for equalizing levels in a multi-carrier system is shown in FIG. 3. In that system, the level adjustment circuit is provided in the form of additional signal processing within the transmission path to the power amplifier. Similar reference numerals are utilized for like components with respect to the embodiments disclosed in FIGS. 1 and 2. In transmitter 70, the input stage 72 incorporates multiple transceivers or multiple modulated RF sources and a gain stage 74 incorporates amplifier 18 and a level adjustment circuit 76 which provides digital level adjustment. To that end, the level adjustment circuit 76 includes an analog downconverter and an analog-to-digital converter (ADC) indicated collectively by block 78. The multiple carriers or inputs P_{IN1}, P_{IN2}, . . . P_{INk} of the multi-carrier waveform are digitally split by a K:1 digital splitter 80. The individual carriers 1, 2, . . . k are then appropriately downconverted to base-band by respective digital downconverters 82. The level adjustment of the individual carriers is provided by digital level adjusters 84. The adjusted signals are then appropriately upconverted by digital upconverters 86 and then combined by a K:1 digital combiner 88. A digital-to-analog converter (DAC) and analog upconverter then upconvert the digital signals to reproduce the carriers in the analog domain at RF for input to power amplifier 18. By coupling off portions of the output signals P_{OUT1}, P_{OUT2}, . . . P_{OUTk} at the antenna port 26 and generating a correction signal V_{C1}, V_{C2}, . . . V_{Ck} for each carrier, the level adjustment circuit 76 is able to adjust the power level of the carriers that are input to the amplifier as discussed above utilizing a comparison of the pilot power output signals P_{PILOT1}, P_{PILOT2}, . . . P_{PILOTk} to the user-defined P_{SET}, or individual P_{SET} levels, such as P_{SET 1}, P_{SET 2}, . . . P_{SET k}, as noted above. The power level correction signals V_{C1}, V_{C2}, . . . . V_{Ck} are utilized by the individual respective digital level adjustment circuits 84 to vary the inputs to the amplifier. A correction signal is thus generated for each of the carrier branches in accordance with the principles of the invention to provide unique gain settings in the digital domain for each carrier.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details of representative apparatus and method, and illustrative examples shown and described. Accordingly, departures may be made from such details without departure from the spirit or scope of applicant's general inventive concept.

What is claimed:

1. A circuit for controlling the output power of a transmitter including a power amplifier comprising:
a pilot detection circuit for detecting the power of a pilot channel from an output of the amplifier, the pilot detection circuit providing a pilot power output signal reflective of the pilot channel power;
a reference circuit for providing a pilot power reference signal;
a comparator circuit coupled to compare the pilot power output signal and reference signal and to provide a power level correction signal;
a level adjustment circuit for adjusting the power level of an input to the amplifier, the level adjustment circuit using the power level correction signal for varying the amplifier input to control the output power level of the amplifier.

2. The circuit of claim 1 wherein the pilot detection circuit includes an A/D converter and a digital downconverter to down convert the amplifier output.

3. The circuit of claim 1 wherein the pilot detection circuit includes a filter circuit to filter a signal portion from the amplifier output.

4. The circuit of claim 3 wherein the pilot detection circuit filter is a digital filter.

5. The circuit of claim 3 wherein the filter circuit is operable for selecting a carrier from an amplifier output including multiple carriers.

6. The circuit of claim 1 wherein the pilot detection circuit includes a demodulator and decorrelator for detecting the power of a pilot channel.

7. The circuit of claim 1 wherein the pilot detection circuit includes a digital signal processing circuit for de-spreading a carrier signal from the amplifier output into individual channels for detecting the power of a pilot channel.

8. The circuit of claim 1 wherein the level adjustment circuit includes a gain adjustment circuit for varying the level of the amplifier input in response to the power level correction signal.

9. The circuit of claim 1 further comprising a multi-carrier transceiver circuit for providing multiple carriers at the amplifier input.

10. The circuit of claim 9 wherein the pilot signal detection circuit is operable for detecting the power of a pilot channel for individual ones of multiple carriers from an output of the amplifier, the pilot signal detection circuit providing multiple pilot power output signals reflective of the pilot channel power of the multiple carriers.

11. The circuit of claim 10 wherein the reference circuit provides multiple pilot power reference signals for comparing to the multiple pilot power output signals.

12. The circuit of claim 10 wherein the comparator circuit provides multiple power level correction signals corresponding to the multiple carriers.

13. The circuit of claim 12 wherein the multi-carrier transceiver circuit includes multiple level adjustment circuits for adjusting the power level of the multiple carriers at the amplifier input, the multi-carrier transceiver circuit using the power level correction signals for varying the amplifier input.

14. The circuit of 1 wherein the level adjustment circuit includes a digital downconverter, a digital level adjustor and a digital upconverter for adjusting the power level of an input to the amplifier in the digital domain.

15. A transmitter with a power amplifier comprising:
a circuit for detecting the power of a pilot channel of a carrier from an output of the amplifier to generate a pilot power output signal reflective of the pilot channel power and for comparing the pilot power output signal to a reference signal and producing a power level correction signal;
a level adjustment circuit for adjusting the power level of an input to the amplifier, the level adjustment circuit using the power level correction signal for varying the amplifier input to control the output power level of the amplifier.

16. The transmitter of claim 15 wherein the pilot detection circuit includes a filter circuit to filter a signal portion from the amplifier output.

17. The transmitter of claim 15 wherein the filter circuit is operable for selecting a carrier from an amplifier output including multiple carriers.

18. The transmitter of claim 15 wherein the pilot detection circuit includes digital signal processing circuitry for de-spreading a carrier signal from the amplifier output into individual channels for detecting the power of a pilot channel.

19. The transmitter of claim 15 wherein the level adjustment circuit includes a gain adjustment circuit for varying the level of the amplifier input in response to the power level correction signal.

20. The transmitter of claim 15 wherein the circuit detects the power of a pilot channel of multiple carriers from an output of the amplifier to generate multiple pilot power output signals reflective of the pilot channel power of respective carriers and compares the pilot power output signals to a reference signal for producing multiple power level correction signals.

21. The transmitter of claim 20 wherein the circuit provides multiple pilot power reference signals and compares them corresponding ones of the multiple pilot power output signals.

22. The transmitter of claim 20 further comprising multiple level adjustment circuits operable for adjusting the power level of respective carriers input to the amplifier, the level adjustment circuits using the multiple power level correction signals for varying the carrier levels to control the output power level of the amplifier.

23. The transmitter of claim 20 wherein the pilot signal detection circuit is operable for detecting the power of a pilot channel for individual ones of multiple carriers from an output of the amplifier, the pilot signal detection circuit providing multiple pilot power output signals reflective of the pilot channel power of the multiple carriers.

24. The transmitter of claim 20 further comprising a multi-carrier transceiver circuit including multiple level adjustment circuits for adjusting the power level of multiple respective carriers at the amplifier input, the multi-carrier transceiver circuit using the power level correction signals for varying the amplifier input.

25. The transmitter of 15 wherein the level adjustment circuit includes a digital downconverter, a digital level adjustor and a digital upconverter for adjusting the power level of an input to the amplifier in the digital domain.

26. A method for controlling the output power of a transmitter comprising:
detecting the power of a pilot channel of a carrier transmitted by the transmitter and generating a pilot power output signal reflective of the pilot channel power;
comparing the pilot power output signal to a reference signal to generate a power level correction signal;
adjusting the output of the transmitter using the power level correction signal.

27. The method of claim 26 wherein the transmitter includes an amplifier and further comprising coupling off a portion of an output of the amplifier and digitizing and downconverting the amplifier output.

28. The method of claim 26 further comprising filtering an output of the transmitter to isolate a carrier for detecting the power of the pilot channel of the carrier.

29. The method of claim 28 further comprising filtering the transmitter output to select a carrier from multiple carriers.

30. The method of claim 26 further comprising de-spreading a carrier signal from the amplifier output into individual channels for detecting the power of a pilot channel.

31. The method of claim 26 wherein the transmitter includes an amplifier and further comprising adjusting the output of the transmitter by adjusting the level of an input to the amplifier using the power level correction signal.

32. The method of claim 26 further comprising detecting the power of a pilot channel of multiple carriers transmitted by the transmitter and generating multiple respective pilot power output signals;
comparing the pilot power output signals to a reference signal to generate multiple power level correction signals.

33. The method of claim 32 further comprising comparing multiple pilot power reference signals to corresponding ones of the multiple pilot power output signals.

34. The method of claim 32 wherein the transmitter includes an amplifier and wherein adjusting the output of the transmitter using the power level correction signals includes adjusting the power level of the multiple carriers that are input to the amplifier.

35. The method of claim 34 wherein the power level adjustment includes digitally downconverting a carrier, digitally level adjusting a carrier and digitally upconverting the carrier.
